(19) United States
(12) Patent Application Publication
(10) Pub. No.: US 2013/0075375 A1
(43) Pub. Date: Mar. 28, 2013

(54) COMPOUND LASER WORKING MACHINE

(71) Applicant: Tsung-I CHEN, New Taipei City (TW)

(72) Inventor: Tsung-I CHEN, New Taipei City (TW)

(21) Appl. No.: 13/243,792

(22) Filed: Sep. 23, 2011

(51) Int. Cl. B23K 26/38; B23K 26/36

(52) U.S. Cl. 219/121.68

(57) ABSTRACT

A compound laser working machine comprises a machine body, an engraving module, a cutting module and a control module. The engraving module is disposed on the machine body and it comprises a metal tube laser for output of engraving operations; the cutting module is disposed on the machine body and it comprises a glass tube laser for output of cutting operations; the control module is disposed on the machine body and it is connected to the engraving module and the cutting module individually, so that the output operations of the engraving module and the cutting module can be controlled by the control module simultaneously or individually.

### BACKGROUND OF THE INVENTION

1. Field of Invention

The present invention relates to a compound laser working machine which can perform both engraving and cutting operations.

2. Related Art

The basic working principle of common laser processing machines is to guide and focus laser beams on surfaces of objects which need to be engraved. The materials of the objects are gasified due to sudden increase of temperature when the focused laser beams are absorbed by the materials, so that the surfaces of the objects are indented. Thus the objective of engraving or cutting is achieved.

The process of engraving and cutting by laser is very simple, just like unto printing on paper by using a computer and a printer. The only difference is, for printing, ink is printed on paper; as for laser engraving, laser is projected on nearly all kinds of materials such as wood, acryl, plastic, metal, stone, etc.

However, existing laser engraving and cutting machines are divided into two types, which are the metal tube laser and the glass tube laser. The watts and prices for the metal tube laser are high which is suitable for engraving, while the watts and prices for the glass tube laser are low which is suitable for cutting. Machines with metal tube laser are chosen to perform engraving, while machines with glass tube laser are chosen to perform cutting. Therefore, users will have to change between machines for engraving or cutting which is inconvenient and much space is required to place the machines; besides, the costs are also increased.

### SUMMARY OF THE INVENTION

A primary object of the present invention is to provide a compound laser working machine which can perform both engraving and cutting operations.

In order to achieve the above-mentioned object, the present invention of a compound laser working machine comprises a machine body, an engraving module, a cutting module and a control module. The engraving module is disposed on the machine body and it comprises a metal tube laser for output of engraving operations; the cutting module is disposed on the machine body and it comprises a glass tube laser for output of cutting operations; the control module is disposed on the machine body and it is connected to the engraving module and the cutting module individually, so that the output operations of the engraving module and the cutting module can be controlled by the control module simultaneously or individually.

When it is embodied, it further comprises a computer module which is disposed on the machine body and is connected to the control module. When the computer module is used to receive at least one command, it drives the control module in order to control the engraving module and the cutting module simultaneously or individually to perform output operations.

When it is embodied, both the metal tube laser of the engraving module and the glass tube laser of the cutting module are carbon dioxide (CO₂) lasers.

When it is embodied, both the metal tube laser and the glass tube laser have a same laser wavelength.

The present invention will become more fully understood by reference to the following detailed description thereof when read in conjunction with the attached drawings.

### BRIEF DESCRIPTION OF THE DRAWINGS

FIG. 1 is a framework of a preferred embodiment of a compound laser working machine of the present invention.

### DETAILED DESCRIPTION OF THE INVENTION

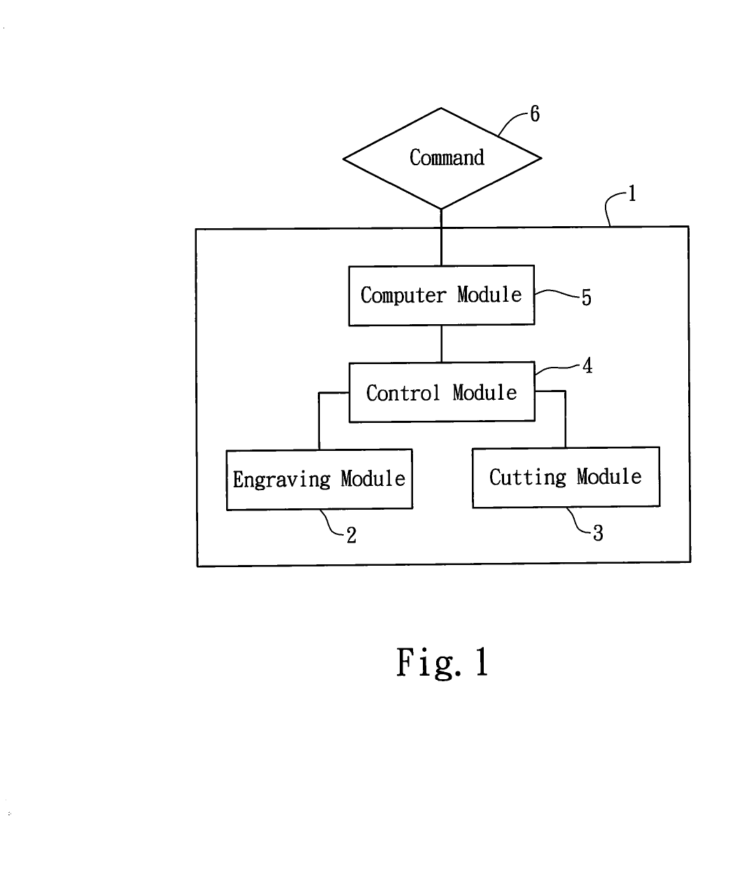

FIG. 1 shows an embodiment of a compound laser working machine of the present invention. It comprises a machine body 1, an engraving module 2, a cutting module 3 and a control module 4.

The engraving module 2 is disposed on the machine body 1, the engraving module 2 comprises a metal tube laser for output of engraving operations; the cutting module 3 is disposed on the machine body 1, the cutting module 3 comprises a glass tube laser for output of cutting operations. Both the metal tube laser of the engraving module 2 and the glass tube laser of the cutting module 3 are carbon dioxide (CO₂) lasers; it is the best for both the metal tube laser and the glass tube laser to have a same laser wavelength. The control module 4 is disposed on the machine body 1, the control module 4 is connected to the engraving module 2 and the cutting module 3 individually, so that the output operations of the engraving module 2 and the cutting module 3 can be controlled by the control module 4 simultaneously or individually.

In addition, the present invention further comprises a computer module 5 which is disposed on the machine body 1 and is connected to the control module 4. When the computer module 5 is used to receive at least one command 6, it drives the control module 4 in order to control the engraving module 2 and the cutting module 3 simultaneously or individually to perform output operations.

Therefore, when it is embodied, users can perform engraving or cutting operation separately on the machine body 1 of a compound laser working machine of the present invention according to the practical requirements. If an engraving operation needs to be performed, input the command 6 or parameters for engraving, the control module 4 is then driven by the computer module 5 in order to control the metal tube laser of the engraving module 2 to carry out the engraving operation. If a cutting operation needs to be performed, input the command 6 or parameters for cutting, the control module 4 is then driven by the computer module 5 in order to control glass tube laser of the cutting module 3 to carry out the cutting operation. If a same workpiece needs to be engraved and cut, it can be done by controlling simultaneously the engraving module 2 and the cutting module 3 to perform the output operations.

Therefore, a compound laser working machine of the present invention can provide both the engraving mode with the metal tube laser and the cutting mode with the glass tube laser; both engraving and cutting operations can be performed simultaneously or separately without the need to install two machines with different working modes of engraving and cutting. As a result, the costs are reduced, and the time of processing can also be reduced in order to enhance the efficiency.

According to the above disclosure, the present invention can certainly achieve the expected objects by providing a compound laser working machine which can be practically applied in related industries.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A compound laser working machine comprising:
a machine body;
an engraving module disposed on the machine body, the engraving module comprising a carbon dioxide metal tube laser for output of engraving operations;
a cutting module disposed on the machine body, the cutting module comprising a carbon dioxide glass tube laser for output of cutting operations; and
a control module disposed on the machine body, the control module is connected to the engraving module and the cutting module individually for simultaneously or individually controlling the engraving module and the cutting module to perform output operations.

2. The compound laser working machine as claimed in claim 1, wherein it further comprises a computer module disposed on the machine body and it is connected to the control module, and the computer module is used for driving the control module to control the engraving module and the cutting module simultaneously or individually to perform output operations after the computer module receives at least one command.

3. The compound laser working machine as claimed in claim 1, wherein both the metal tube laser and the glass tube laser have a same laser wavelength.
